(19) United States
(12) Patent Application Publication
(10) Pub. No.: US 2011/0237147 A1
(43) Pub. Date: Sep. 29, 2011

(54) Textile fiber batting substitution for foam structures

(75) Inventor: Robert Alton Usher, JR., Charlotte, NC (US)

(73) Assignee: David C. Poole Company, Inc., Greenville, SC (US)

(21) Appl. No.: 13/065,486

(22) Filed: Mar. 23, 2011

Related U.S. Application Data
(60) Provisional application No. 61/316,574, filed on Mar. 23, 2010.

(51) Int. Cl. D04H 1/50; D04H 3/14; D04H 13/00; B32B 37/02; B32B 38/00

(52) U.S. Cl. 442/353; 442/352; 442/359; 442/411; 156/62.8

(57) ABSTRACT

A textile cushioning batting for use in furniture and the like having a high degree of loft and rebound is disclosed comprising: a non-woven blended batting comprising a major portion of a fine denier fiber and a minor portion of a coarse denier fiber. The fibers have increased crimping amplitudes, secondary crimping, sharper crimp and optimized crimps per inch. A low melt binds fiber binding the fine and coarse denier fibers together in the batting; and a sufficient number of the fibers being heat are bonded together at their intersections to provide a high loft resilient batting for cushioning.

This application claims the benefit of the filing date of provisional application No. 61/316,574, filed Mar. 23, 2010.

### FIELD OF THE INVENTION

This invention relates to resilient, polymer fiber textile structures for cushioning textile batting and similar uses.

### BACKGROUND OF THE INVENTION

The existing cushioning systems in primary use for outdoor and indoor furniture consist mainly of urethane and other similar polymer, i.e. foams, plus a few recently developed fiber structures. Polyurethane has long been the standard for cushion and seat backings, but increases in the cost of urethane, plus inherent environmental and safety/flame retardant concerns have pushed the market to look for other solutions. One of the principal areas of investigation has been in the use of layered fiber structures.

In the prior art, for example, a bonded layered polyester (PET) fiber battinging is described in U.S. Pat. No. 4,869,771 which issued to Martin LeVan on Sep. 26, 1989, and fiberfill products comprising polytrimethylene terephthalate (PTT) stable fibers are described in Publication No. US 2002/0153641 A1 to Ismael A. Hernandez et al. In addition, U.S. Pat. No. 3,917,448 which issued to Dennis Woods discloses random fiber webs with improved lofts. Accordingly, it is one object of the invention to provide a cushioning material in the form of a fibrous batting having improved loft and rebound by using a unique combination of blended polymeric fibers and fiber diameters.

A prior art example of blending polyester fiber is described in U.S. Pat. No. 4,281,042 where crimped and non-crimped, regular denier fibers are blended for pillows and cushions. Thus, another object of the invention is to provide unique and improved polyester blends of specially crimped fibers for improved cushioning characteristics.

### SUMMARY OF THE INVENTION

The present invention is a novel fiber battinging structure, achieved by a combination of unique fiber chemistry, a combination of different fiber diameters, and a combination of fiber attributes, which resolves many of the problems previously encountered in attempts to substitute fiber for foam, and results in a higher loft and cushioning.

In a first aspect, the invention comprises the steps of blending selected proportions of fibers of different diameters, preferably, in the range from 20 to 200 denier with specific ranges being preferred, in a web making process, such as carding. Low melt fibers are blended with the selected diameter fibers during web formation. The web is then layered with additional webs prior to heat setting to form battinging and the resulting battinging has many of the positive without the negative attributes of the traditional industry standard, polyurethane foam. In this case, the larger diameter or coarse fibers greatly enhance the “push-back” or rebound of the structure and give it a foam-like resilience. The blend of a coarse denier fiber with a fine denier fiber provides a better performing product than a single denier product with the same average denier.

In a second aspect, the invention comprises the steps of blending two key polymers, polyethylene terephthalate (PET) and polytrimethylene terephthalate (PTT) in a predetermined ratio and extruding the mixed polymers into fibers or filaments of different selected diameters, preferably in the range of 20 to 200 denier for use in a web making process, such as carding. Low melt fiber is blended with the selected diameter fibers during web formation, the web is layered with additional webs prior to heat setting to form batting material, that has many of the desirable features and without the negative attributes of the traditional industry standard, polyurethane foam.

In a third aspect, the invention comprises the steps of blending polyethylene terephthalate (PET) and polytrimethylene terephthalate (PTT) in a selected proportion in an extrusion, textile feed hopper, or other fiber process to form a coarse fiber, then blending these fibers in a web making process, such as carding with other fibers, preferably PET of fine denier. Alternately, coarse staple PET and PTT may be blended in desired ratios in a feed hopper, and then fed to the carding machine. The low melt fiber is blended with the selected diameter fibers during web formation, the web may be layered with additional webs prior to heat setting to form batting material that has many of the positive characteristics without the detriments of polyurethane foam.

In a fourth aspect, the present invention is a process of blending selected proportions of different diameters (deniers) as in the process of the first aspect above (par. 0006) and coextruded polymers as in the second (par. 0007) and third (par. 0008) aspects to enhance the bulking properties of the coarse and fine denier fibers by increasing the crimping amplitude and secondary crimp and sharpening the crimp angle to a more V-shape versus U-shape and optimizing the crimps per inch, thereby increasing battinging thickness, resilience and firmness.

In yet a further aspect, the invention is a process of blending fine denier and coarse denier fibers where the majority of the fibers are fine and forming battings of the blend to provide an improved cushioning material.

In one example, a textile batting for use as a cushioning material in furniture and the like comprises a fiber blend comprising 20% to 50% coarse fibers and 50% to 80% finer fibers; said coarse fibers having denier of 35 to 70 and said finer fibers having a denier of 10 to 20 denier; and a low melt fiber melted in said fiber blend for binding and reinforcing said fiber blend. The coarse fibers of the fiber blend may advantageously include about 35% PTT.

A process for producing the textile batting includes the steps of blending a minor portion of coarse denier fibers with a major portion of fine denier fibers to produce a fiber blend. The fibers of the fiber blend are then crimped and heat set. The blended fibers are then subjected to carding to form a thin web. Subsequently, the carded web is layered or cross lapped in multiple layers while low-melt fiber is added to the blend. The batting is then heated to cause the low-melt fiber to bind and reinforce the batting. Advantageously, a finishing lubricant is added to the fibers during fiber crimping to change the form of the crimp into a sharper, generally saw-tooth form with a high amplitude and peak for additional resiliency and rebound.

### DESCRIPTION OF THE DRAWINGS

The drawings, which are attached hereto and made a part of this disclosure by way of illustration and not by way of limitation, are briefly described below.

FIG. 1 is a graph illustrating that coarser denier fiber battings have increased resiliency similar to foam with increased loading cycles;

FIG. 2 is a graph illustrating the change in loft versus loading cycles for foam, 15 denier fiber and 45 denier fiber;

FIG. 3 illustrates the batting indention force for deflection versus loading cycles;

FIG. 4 is a chart showing the propensity to return to the original loft height as a function of loading cycles;

FIG. 5 illustrates the reduction in cost of fiber batting compared to foam;

FIG. 6 is a schematic flow diagram of a textile process for producing a high loft and rebound fiber batting for cushion according to the invention;

FIG. 7 is a schematic flow diagram for a textile finishing line for finishing the bale of FIG. 6 according to the invention;

FIGS. 8A-8B are crimp diagrams of fibers crimped with addition of a finishing lubricant according to the invention and prior art crimped fibers; and

FIG. 9 is an upholstered cushion with cover cut away to show a batting cushioning according to the invention.

### DETAILED DESCRIPTION

The blending of coarse (larger diameter) fibers with finer (smaller diameter) fibers yields a cushion structure with significantly more loft and “push-back” due to the increased rigidity of the coarse fiber, yet retains a comfortable feel due to the softness of the finer fibers. The percentage of larger diameter fibers blended with traditional smaller diameter fibers is controlled to optimize the push back desired and without an unacceptable loss in the bonding points required for batting strength and durability.

The blending of thermoplastic polymers (for example PET and PTT) to manufacture fibers in certain proportions yields an enhanced ability of the coarse fibers of the smaller portion of the blend (in a cushion) once loaded, for example, by a person sitting on the cushion, to recover to their preloading shape, an attribute normally associated with PTT but not PET. The PET brings a high tensile property to the structure, an attribute normally associated with PET but not PTT. The coarse (high denier) fibers bring a stiffness or resistance to being compressed to the cushion, which is typical of coarse fiber but not normally fine fiber. Thus, surprisingly, the invention offers many of the desired features of each polymer/fiber, with few and insignificant negatives. Suitable thermoplastic fibers include polyester, polypropylene, and nylon.

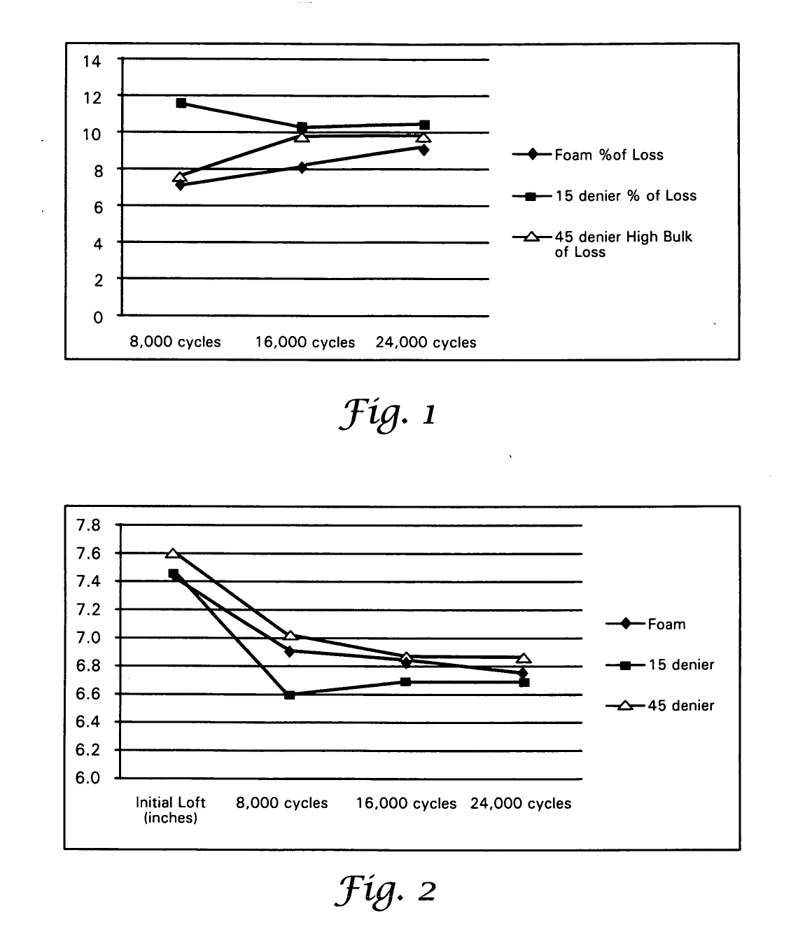

Referring to FIG. 1, PET with coarse denier fibers, e.g., 45 denier, the middle line of the graph, form resultant battings that have an increased resiliency and an ability to achieve increased loading as compared to fine denier and is somewhat superior to urethane foam. The graph shows percent of loss of resiliency versus number of loading cycles.

Battings of coarse fiber, e.g., 45 denier, have an increased initial loft as shown in FIG. 2 exceeding both regular foam and fine denier battings.

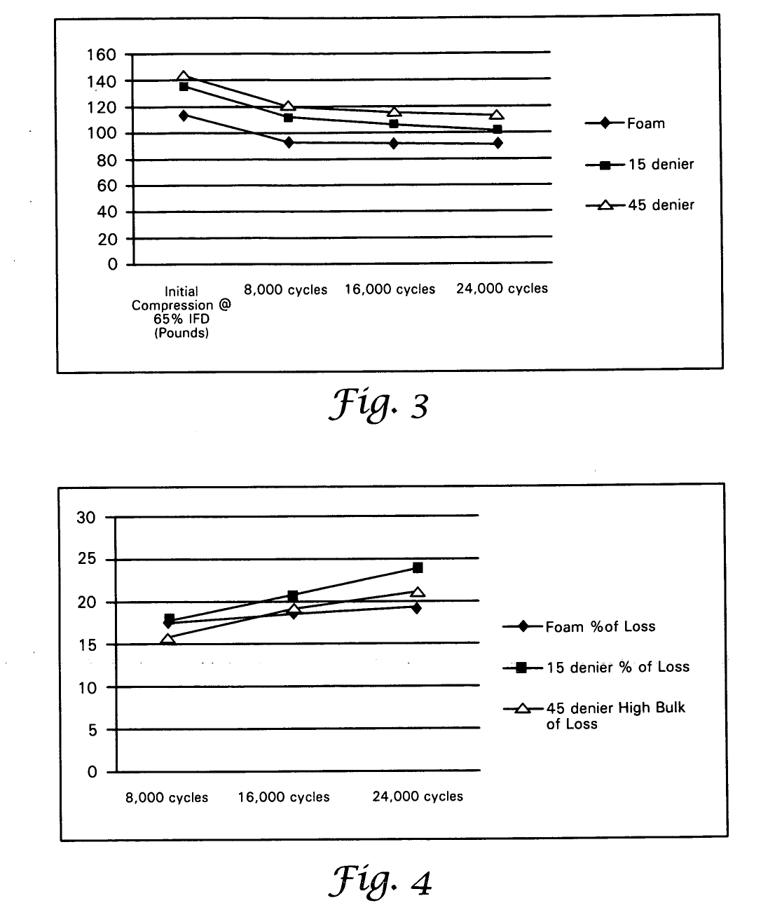

With coarse denier fibers, the resultant battings have an increased indention force deflection or IFD at the industry standard of 65% as shown in FIG. 3, thus exceeding both regular fiber foam substitutes (15 denier) and, in many cases, the standard foam structures.

In addition, in the case of coarse denier fibers, the resultant battings have an increased propensity to return to the structures original loft or height as shown in FIG. 4 and retain a high level of resilience exceeding the regular fiber foam substitutes and approaching that of the standard foam structures.

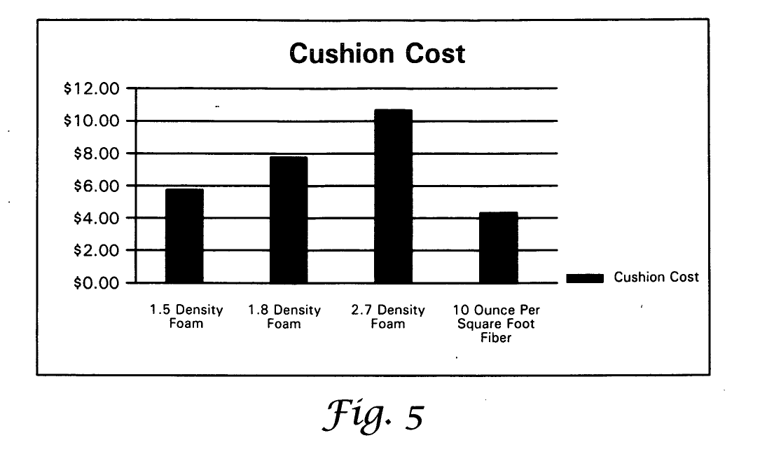

Regarding costs, coarse denier fibers provide batting that have a significant potential cost advantage (see FIG. 5) versus standard foam structures further demonstrating the advantages of using coarse fibers as part of a batting.

FIG. 5 shows the relative costs of fiber versus foam and demonstrates the advantage of fiber cushioning according to the present invention.

### DESCRIPTION OF A PREFERRED EMBODIMENT

In a preferred embodiment of the invention, a cushion batting 10 comprises a minority blend of coarse fibers of PET or a PET/PTT blend and a majority blend of fine fibers. Multiple webs are combined form a batting structure of a desired thickness. Low melt fibers are added to the batting structure which is heated to the bonding temperature of the low melt fibers, whereupon at the intersection of the fibers bonding takes place. After cooling an intertwined network of fibers or batting is formed, having improved loft and resilience for a high number of cycles and reduced cost.

The fibers of each of the preferred embodiments are crimped having a sharper crimp angle (saw tooth versus sinusoidal) and greater crimp amplitude than in conventional crimping processes. Conventional crimping for PET and PTT fibers is described in the above-mentioned publication of Hernandez, et al. However, in the present invention, it has been found that introducing a finishing lubricant 25 to the fibers during crimping changes the form of the crimp, a sharp saw tooth crimp with higher amplitude (8A) as opposed to the sinusoidal shape of the prior at (8B). This saw tooth crimp provides more loft, resiliency, and rebound. A suitable lubricant is QCF manufactured by Momentive Specialty Chemicals, Roebuck, S.C.

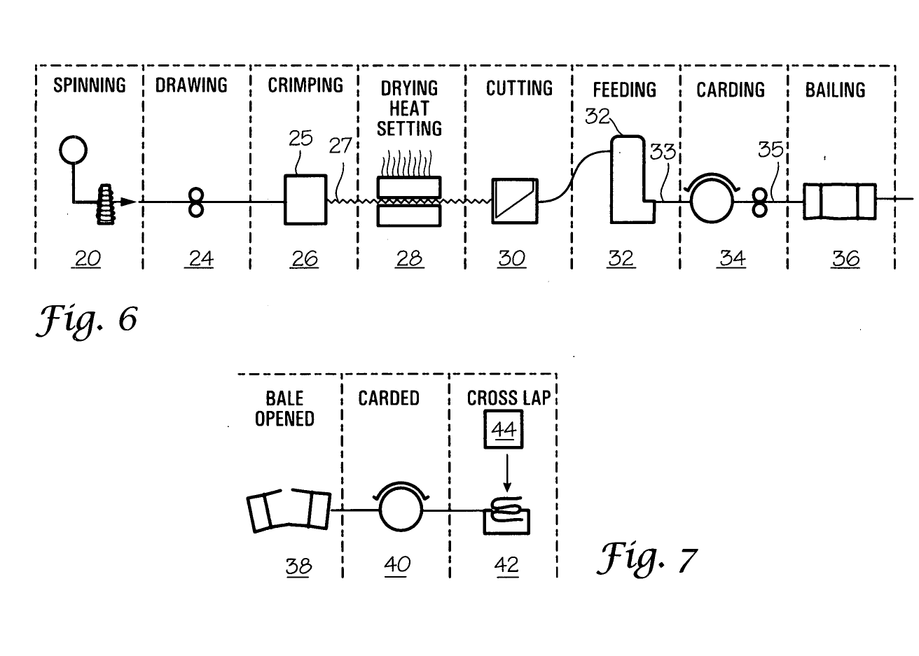

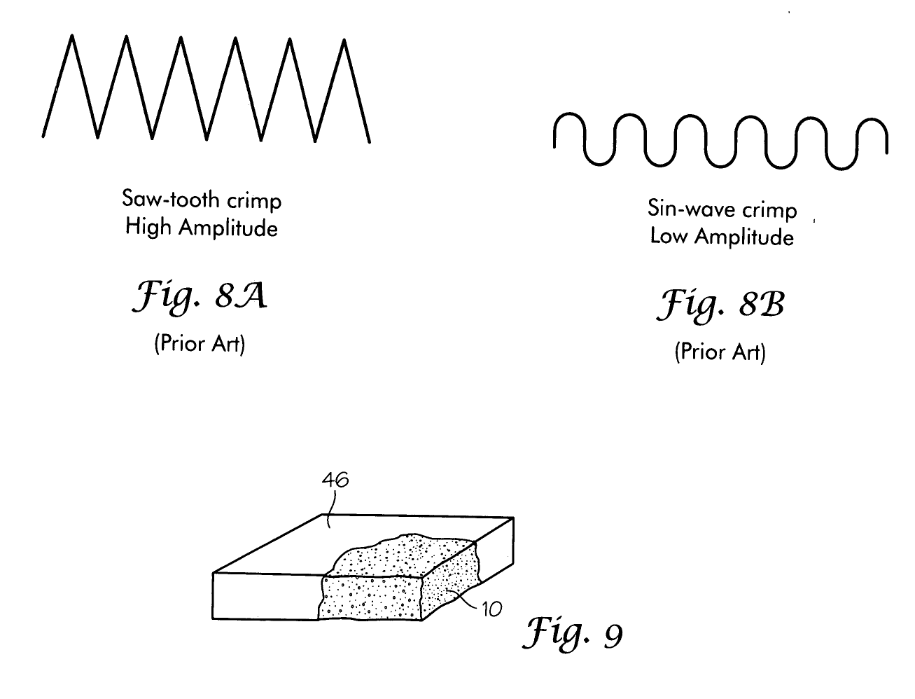

Referring now to FIG. 6, a schematic illustration of a textile process for making the cushion batting 10 of the present invention will be explained. One of ordinary skill in the art will be familiar with the textile equipment used at the various stages of production, and the substitutions therefor. Therefore, the equipment will not be explained in detail. At the first station 20 fiber forming substances are fed into a spinneret which forms a filament 22 which is subjected to drawing at station 24. Next the drawn filament is fed to a crimping station 26 wherein the yarn is crimped in a conventional manner. However in the case of the invention, a finishing lubricant 25 is added to the yarn during crimping which provides advantages to the fiber batting resulting from the invention insofar as providing increased resiliency and push back to shape. Next, the crimped yarn 27 is subjected to heating at station 28 where the crimp is set. The crimped yarn is then sent to a cutting station 30 where the crimped yarn is cut into short staples. The staple is fed to a feeding hopper 31 at feeding station 32. The output from the feeding hopper is typically a thin light web 33 which is supported and fed by a feed roll or table to a carding machine at 34. Finally, the thin web is carded into a denser web 35. The web is cut and laid in a bale at a baling station 36.

At this point, the bale may be opened at 38 and the fibers either carded again in the first process or the bale may be sent to a customer who recards the blend and adds the low melt fiber or bicomponent yarn. In either case, the web is recarded at 40 and cross-lapped at 42 whereupon the bicomponent low melt fiber 44 is added to the web during cross-lap. In the final manufacture, the lapped fiber webs with the low melt bicomponent are cut into the desired cushion shape and pressed. The cushion batting 10 is then covered with a textile cushion cover 46 as shown in FIG. 9.

Regarding the blend of denier and weight of the yarn, the coarse fiber is preferably selected from a range of 35 to 70 denier, and the fine yarn in a range of 10 to 20 denier. The blend by weight is selected in the range of about 20 to 50% coarse fiber and 50 to 80% fine fiber. The fibers are in a weight range to form a staple fiber tow which is carded into a thin web. In some applications, fiber from 20 to 200 denier may be practical.

In one example of the invention, regular polyester is used as the coarse and the fine denier fibers. The blend weight of the coarse and fine fiber is about 30% and 70%, respectively. Preferably, the coarse polyester fiber is 45 denier, and the fine polyester fiber is 15 denier. The blend is 35% by weight of 45 denier fiber; 45% by weight of 15 denier fiber, and 20% by weight of 7 denier of low melt fiber or bi-component fiber. The low melt fiber may be low melt polyester or other suitable fiber. The bicomponent may be polyester core with a polyethylene core.

In an advantageous embodiment, the coarse fiber may be a blend of PET and PTT wherein the PTT adds to the resiliency and rebound quality. In one example, a blend of 20% PTT and 80% PET, 45 denier, is utilized. As described above the PET and PTT may be co-extruded in a spinneret 21, or may be blended in feed hopper 32 and the like prior to carding at the desired blend.

While a preferred embodiment of the invention has been described using specific terms, such description is for illustrative purposes only, and it is to be under-stood that changes and variations may be made without department from the spirit or scope of the following claims.

What is claimed:

1. A textile cushioning batting for use in furniture and the like having a high degree of loft and rebound comprising:
a non-woven blended batting comprising a major portion of a fine denier fiber and a minor portion of a coarse denier fiber,
said fibers having increased crimping amplitudes, secondary crimping, sharper crimp and optimized crimps per inch,
a low melt binder fiber binding said fine and coarse denier fibers together in said batting; and
a sufficient number of said fibers being heat bonded together at their intersections to provide a resilient batting.

2. The textile batting of claim 1 wherein said coarse fibers have a denier selected from a range of about 20 to 200 denier.

3. The textile batting of claim 1 wherein the coarse fibers comprise about 20 to 50% of the blend and the fine denier fiber comprises about 50 to 80% of the blend.

4. The cushioning batting of claim 3 wherein said coarse fibers have a denier of about 35 to 70 denier, and said finer fibers have a denier of about 10 to 20 denier.

5. The textile batting of claim 2 wherein the coarse fiber comprises about 30% of the blend and the fine denier fiber comprises about 70% of the blend.

6. The textile batting of claim 5 wherein said coarse fibers are about 45 denier and said finer fibers are about 15 denier.

7. The textile batting of claim 1 wherein both the coarse fiber and the fine fiber include PET.

8. The textile batting of claim 7 wherein the coarse fiber includes a blend having a major portion of PET and a minor portion of PTT.

9. The textile batting of claim 8 wherein the coarse fiber of the textile batting comprises about 35% PTT and the fine fiber comprises about 45% PET.

10. The cushioning batting of claim 1 wherein said coarse and fine fibers are crimped by applying a finishing lubricant to said fibers during crimping to provide generally saw tooth crimps having higher sharpness and amplitude.

11. The textile batting of claim 1 wherein said low-melt fiber includes low-melt bi-component fibers including a fiber core surrounded by a low-melt sheath.

12. A textile batting for use as a cushioning material in furniture and the like comprising a fiber blend comprising 20% to 50% coarse fibers and 50% to 80% finer fibers; said coarse fibers having denier of 35 to 70 and said finer fibers having a denier of 10 to 20; and a low melt fiber melted in said fiber blend for binding and reinforcing said fiber blend.

13. The textile batting of claim 12 wherein both the coarse fiber and the fine fiber include PET.

14. The textile batting of claim 13 wherein the coarse fibers of the fiber blend include about 35% PTT.

15. The textile batting of claim 14 wherein the coarse fiber includes a blend having a major portion of PET and a minor portion of PTT.

16. The textile batting of claim 12 wherein said coarse and fine fibers are crimped by applying a finishing lubricant to said fibers to provide generally saw tooth crimps having higher sharpness and amplitude for resiliency.

17. A process for producing a textile batting of blended non-woven polymeric fibers for use as a cushion in furniture and the like comprising the steps of:
blending a minor portion of coarse fibers and a major portion of finer fibers;
blending said coarse fibers with fine denier fibers to form blended fibers;
crimping the blended fibers;
carding the crimped blended fibers to form a web;
layering a plurality of said webs to form a batting;
introducing low-melt fibers into said batting;
applying heat to said batting and low-melt fiber to cause heat bonding at a sufficient number of intersections of said blended fibers to reinforce and provide a three-dimensional, resilient textile cushioning batting.

18. The process of claim 17 including introducing a finishing lubricant during fiber crimping to change the form of the crimp into a sharper, generally saw-tooth form with a high amplitude and peak.

19. The process of claim 17 including blending said coarse fibers in a fiber blend of about 20 to 50 percent to 50 to 80 percent fine fibers, and selecting said coarse fiber from a range of about 35 to 70 denier and selecting said fine denier fibers from a range of about 10 to 20 denier.

20. The process of claim 17 including blending said fiber blend from PET fibers and including PTT fibers in said coarse fibers along with said PET fibers.
